(19) United States
(12) Patent Application Publication
(10) Pub. No.: US 2022/0236422 A1
(43) Pub. Date: Jul. 28, 2022

(54) METHOD, DEVICE AND SYSTEM FOR ANALYZING TUNNEL CLEARANCE BASED ON LASER POINT CLOUD

(71) Applicant: Nanjing University of Aeronautics and Astronautics, Nanjing (CN)

(72) Inventors: Jun WANG, Nanjing (CN); Yuxiang WU, Nanjing (CN); Dening LU, Nanjing (CN)

(21) Appl. No.: 17/719,284

(22) Filed: Apr. 12, 2022

Related U.S. Application Data
(63) Continuation-in-part of application No. 17/169,541, filed on Feb. 7, 2021.

(30) Foreign Application Priority Data
Mar. 25, 2020 (CN) 202010218307.4

(51) Int. Cl. G01S 17/89

(52) U.S. Cl. CPC G01S 17/89

(57) ABSTRACT

A point cloud of a tunnel is obtained. The point cloud of the tunnel is subjected to cylinder fitting. A central axis of the tunnel is extracted. A cross section of the tunnel is extracted. Point clouds of two rails are extracted. A base line of a contour of the tunnel clearance is constructed. A center of the cross section of the tunnel is extracted. A point cloud of the cross section of the tunnel is registered with a point cloud of a contour of the tunnel clearance according to a constraint condition. The point cloud of the cross section of the tunnel and the point cloud of the contour of the tunnel clearance after being registered with each other are analyzed to determine whether the tunnel clearance is intruded.

### CROSS-REFERENCE TO RELATED APPLICATIONS

This application is a continuation-in-part application of pending U.S. patent application Ser. No. 17/169,541, filed on Feb. 7, 2021, which claims the benefit of priority from Chinese Patent Application No. 202010218307.4, filed on Mar. 25, 2020. The content of the aforementioned application, including any intervening amendments thereto, is incorporated herein by reference in its entirety.

### TECHNICAL FIELD

The present application relates to tunnel clearance analysis, and in particular to a method, a device and a system for analyzing tunnel clearance based on a laser point cloud.

### BACKGROUND

As the rail transit technology rapidly develops, infrastructures of subway tunnels built many years ago are required to be maintained. The newly built subway tunnels may be subjected to deformation due to comprehensive factors, such as geology, groundwater, construction of adjacent foundation pits, and its structural load. This has an inverse impact on the safety of the tunnel and the operation of the trains. Therefore, deformation monitoring must be carried out in a timely and accurate manner to inspect and forecast dangerous situations in time to ensure the safety of tunnel operation. In particular, the results of tunnel deformation analysis and boundary analysis are directly related to the safe operations of trains. If the deformation trend of the subway tunnel is not warned in time, the tunnel will deform. Since the tunnel segments have greater rigidity, when the cylindrical tunnels deform, the tension and compression are exerted at joints of the segments, resulting in fragmentation at both ends of the segments and failure of waterstop, which will further damage the tunnel infrastructure.

Generally, tunnels are manually and visually inspected, which has low efficiency and accuracy, and consumes a lot of manpower and material resources. In recent years, with the expansion of the construction scale of urban subway projects, the 3D laser scanning technology is gradually adopted for the inspection of subway tunnels. The acquired large-scale 3D laser point cloud data contains coordinate information of the tunnel and laser reflectivity information, so that the deformation state of the tunnel surface is accurately reflected. However, the discrete data obtained by the traditional total station measurement has low data integrity and low precision, and subsequent data processing is difficult. The recently emerging rail vehicle system has overcome this problem. The deformation of the tunnel is analyzed through the tunnel point cloud data obtained through vehicle-mounted 3D laser scanning system, so as to take timely measures to deal with the problems that may occur in the subway tunnel. For example, Chinese Patent Publication No. 108731640 A discloses a method and a system for inspecting tunnel clearance based on point cloud data. The method includes the following steps. The measurement data of a tunnel is obtained, where the measurement data includes point cloud data collected by a laser scanner. A cross-sectional view of the tunnel is generated based on the measurement data. Clearance parameters of a subway are obtained, and a clearance diagram of the subway is generated according to the clearance parameters. The clearance diagram is compared to the cross-sectional view, and a clearance analysis result is obtained according to standard parameters of clearance inspection of the subway, so that the clearance of the subway is automatically inspected. Moreover, by using the point cloud data collected by the laser scanner, the three-dimensional full-angle measurement of the subway tunnel space is realized, which improves the inspection accuracy.

In the aforementioned method, the standard parameters of the clearance inspection should be known. In addition, in the scanning process of the subway tunnel, the initial state calibration of the mobile scanning is not strictly perpendicular to the tunnel axis, and the equipment vibrates during the movement. Thus, the subway deformation information and tunnel clearance analysis results cannot be directly obtained through the point cloud data of the scanned subway tunnel, and pre-processing and post-analysis are required for the scanned data. In addition, a expensive inspection device should be built to improve the accuracy of the point cloud data.

Chinese Patent Publication No. 110793501 A discloses an inspection method for tunnel clearance, which overcomes shortcomings of low efficiency and high cost in the intrusion inspection of the tunnel. The point cloud of the tunnel section is obtained through the three-dimensional laser scanning device, and the circumscribed rectangular frame of the point cloud of the tunnel section is generated. The point cloud of the tunnel section in the rectangular frame is converted into a cross-sectional image. Feature points of the tunnel in the cross-sectional image are marked to obtain a sample set. A regression model is built based on convolutional neural network, and is trained and tested through the sample set obtained by marking. Then, predictions are made through the regression model. The contour line of the rail vehicle is obtained, and feature points are obtained to unify the coordinates of the rail vehicle and the coordinate of the point cloud of the tunnel section, and then they are superimposed. Whether the rail vehicle intrudes the clearance of the tunnel is determined based on the regression model. This method can unify the coordinate system of the rail vehicle and the point cloud of the cross section of the tunnel through model calculation, so that the intrusion can be efficiently and conveniently judged. However, a large amount of sample data is required for the regression model, and the calculation process is complicated. In addition, different models should be recreated for tunnels of different structures, and the method has low accuracy and efficiency. Thus, it cannot meet the requirements of modern tunnel inspection and monitoring.

There is no method to determine whether the tunnel section intrudes the tunnel clearance.

### SUMMARY OF THE DISCLOSURE

The present disclosure aims to provide a method, a device and a system for analyzing tunnel clearance based on a laser point cloud.

The technical solutions of the present disclosure are described as follows.

In a first aspect, the present disclosure provides a method for analyzing tunnel clearance based on a laser point cloud, comprising:

1) obtaining a point cloud of a tunnel;

2) subjecting the point cloud of the tunnel to cylinder fitting; extracting a central axis of the tunnel; and extracting a point cloud of a cross section of the tunnel;

3) extracting point clouds of two rails from the point cloud of the tunnel;

4) constructing a base line of a contour of the tunnel clearance; extracting a center of the cross section of the tunnel; and registering the point cloud of the cross section of the tunnel and a point cloud of the contour of the tunnel clearance according to a constraint condition;
41) selecting a highest point in the point clouds of the two rails respectively to construct the base line; and calculating a slope of the base line;
42) subjecting the cross section to circle fitting using random sample consensus (RANSAC) to obtain the center of the cross section of the tunnel and an x-coordinate of the center; and
43) registering the point cloud of the cross section of the tunnel and the point cloud of the contour of the tunnel clearance according to the constraint condition: a) a bottom edge of the contour of the tunnel clearance coincides with the base line; and b) an x-coordinate of a center of the contour of the tunnel clearance is equal to the x-coordinate of the center of the cross section of the tunnel; and

5) analyzing the point cloud of the cross section of the tunnel and the point cloud of the contour of the tunnel clearance after being registered with each other to determine whether the tunnel clearance is intruded.

In some embodiments, the step (1) comprises:

scanning the tunnel using a three-dimensional laser scanner to obtain the point cloud of the tunnel; and

diving the point cloud of the tunnel into sections of equal length.

In some embodiments, the tunnel in each section contains 10 tunnel segments.

In some embodiments, the step (2) comprises:

21) subjecting the point cloud of the tunnel to the cylinder fitting through Gaussian mapping to extract the central axis of the tunnel;

22) extracting the point cloud of the cross section of the tunnel; wherein the point cloud of the cross section of the tunnel is defined as follows:

$${P}_{C} = \{ {t}_{i} ∈ {P}_{T} ‖ \frac{( {t}_{i} - {a}_{i} ) \cdot T}{‖ {t}_{i} - {a}_{i} ‖} \vert < ɛ \} ;$$

where P_{C}, is the point cloud of the cross section of the tunnel; tᵢ is a point in the point cloud of the tunnel; P_{T} is the point cloud of the tunnel; aᵢ is a point on the central axis of the tunnel; T is a unit tangent vector of the central axis at the point aᵢ; and ε is a threshold; and

23) projecting the point cloud of the cross section of the tunnel along the central axis of the tunnel to obtain a two-dimensional point cloud of the cross section of the tunnel.

In some embodiments, the step (3) comprises:

extracting point clouds of the two rails from the point cloud of the tunnel;

selecting points pᵢ and pⱼ from the point clouds of the two rails; and

clustering the point clouds of the two rails using Euclidean distance.

In some embodiments, the step (5) comprises:

for a point p_i in the point cloud of the cross section of the tunnel, searching the closest point p_in in the point cloud of the contour of the tunnel clearance through K-Nearest Neighbors (KNN); and determining whether the tunnel clearance is intruded through an intrusion function:

S=∥p_i−c∥−∥p_in−c∥;

wherein p_i is any point in the point cloud of the cross section of the tunnel; p_in is the closest point searched by KNN in the point cloud of the contour of the tunnel clearance; c is the center of the cross section of the tunnel; and when S<0, the tunnel clearance is intruded; otherwise, the tunnel clearance is not intruded.

In a second aspect, the present disclosure provides a device for analyzing tunnel clearance based on a laser point cloud, comprising:

a data acquisition module, configured to acquire a point cloud of a tunnel;

a preprocessing module, configured to subject the point cloud of the tunnel to cylinder fitting, extract a central axis of the tunnel, extract a point cloud of a cross section of the tunnel and extracting point clouds of two rails from the point cloud of the tunnel; and

an analysis module, configured to construct a base line of a contour of the tunnel clearance, extract a center of the cross section of the tunnel and register the point cloud of the cross section of the tunnel and a point cloud of the contour of the tunnel clearance according to a constraint condition.

In a third aspect, the present disclosure provides a system for analyzing tunnel clearance based on a laser point cloud, comprising:

a three-dimensional scanner;

a processor;

a storage; and

a program, stored on the storage, for executing the method of claim 1;

wherein the system is mounted on a tunnel inspection vehicle; and

the three-dimensional scanner is connected to the processor, and is configured to scan the tunnel to obtain point cloud of the tunnel and send the obtained point cloud of the tunnel to the processor.

Compared to the prior art, the technical solutions of the present disclosure have the following beneficial effects.

1) The initial state of the mobile scanning is not required to be strictly perpendicular to the tunnel axis. The method has strong robustness, in which data noise is allowed in the analysis process.

2) After point clouds of two rails are extracted, a base line of a contour of tunnel clearance is constructed, and a point cloud of a tunnel section is registered with the point cloud of the contour according to a constraint condition, so as to accurately obtain a relative position relationship between the tunnel clearance and the tunnel section, so that the intrusion is quickly determined. The method has high judgment accuracy and is not limited to a specific structure tunnel, so it has strong applicability.

It should be understood that all combinations of the aforementioned concepts and the additional concepts described in detail below can be regarded as part of the subject matter of the present disclosure unless conflicted. In addition, all combinations of the subject matter are regarded as part of the subject matter of the present disclosure.

The present disclosure will be described below with reference to the embodiments and the accompanying drawings, from which features and beneficial effects of the present disclosure will be clear.

### BRIEF DESCRIPTION OF THE DRAWINGS

The drawings are illustrative in nature and are not drawn to scale. Throughout the drawings, like reference numerals refer to identical or functionally similar elements. For clarity, not every component is labeled in every figure. The embodiments of the present disclosure are illustrated below with reference to the accompanying drawings.

FIG. 1 is a flowchart of a method for analyzing tunnel clearance based on a laser point cloud according to at least one embodiment of the present disclosure;

FIG. 2 schematically depicts a point cloud of a subway tunnel containing 10 tunnel segments according to at least one embodiment of the present disclosure;

FIG. 3 schematically depicts a process for extracting a point cloud of a cross section of the subway tunnel according to at least one embodiment of the present disclosure;

FIG. 4 schematically depicts point clouds of two rails according to at least one embodiment of the present disclosure;

FIG. 5 schematically depicts a point cloud of a contour of tunnel clearance according to at least one embodiment of the present disclosure;

FIG. 6 schematically depicts a constraint condition according to at least one embodiment of the present disclosure;

FIG. 7 schematically depicts a clearance analysis on the subway tunnel according to at least one embodiment of the present disclosure; and

FIG. 8 schematically depicts a device for analyzing tunnel clearance based on laser point clouds according to at least one embodiment of the present disclosure.

### DETAILED DESCRIPTION OF EMBODIMENTS

The embodiments of the present disclosure will be described in detail below with reference to the accompanying drawings, from which technical solutions of the present disclosure become clear.

### Embodiment 1

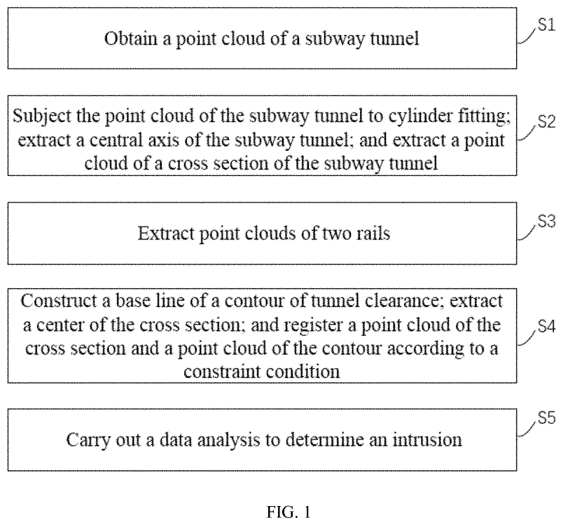

This embodiment illustrates a method for analyzing tunnel clearance based on laser point clouds, which can be directly applied to various laser point clouds based clearance analysis devices of subway tunnels. In specific implementation, the application can be realized by writing corresponding programs in controllers of clearance analysis device of the subway tunnel. As shown in FIG. 1, the method includes the following steps.

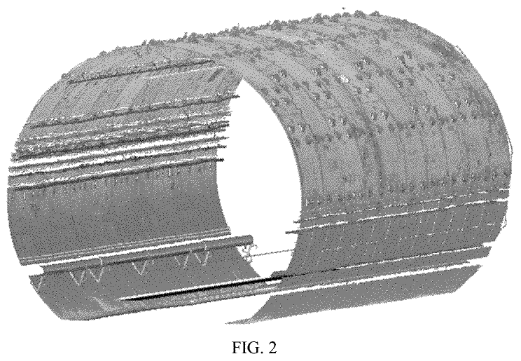

S1) A point cloud of a subway tunnel is obtained. Specifically, the tunnel is scanned by a three-dimensional scanner based tunnel inspection vehicle to obtain the point cloud of the subway tunnel. The point cloud of the subway tunnel is divided into sections with equal length, such that the subway tunnel in each section contains ten tunnel segments. A point cloud of the subway tunnel containing ten tunnel segments as shown FIG. 2 is taken as the point cloud of the subway tunnel hereinafter.

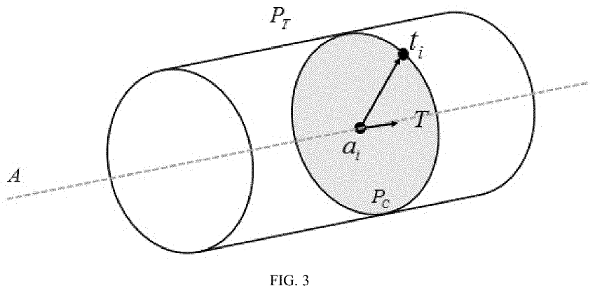

S2) The point cloud of the subway tunnel is subjected to cylinder fitting through Gaussian mapping. A central axis A of the subway tunnel is extracted, and a point cloud of a single cross section of the subway tunnel is extracted as illustrated in FIG. 3. Specifically, the point cloud of the cross section is defined as follows:

$${P}_{C} = \{ {t}_{i} ∈ {P}_{T} ‖ \frac{( {t}_{i} - {a}_{i} ) \cdot T}{‖ {t}_{i} - {a}_{i} ‖} \vert < ɛ \} ;$$

in which P_{C}, is the point cloud of the cross section; tᵢ is a point in the point cloud of the subway tunnel; P_{T} is the point cloud of the subway tunnel; aᵢ is a point on the central axis A; T is a unit tangent vector of the central axis A at the point aᵢ; and ε is a threshold.

The point cloud of the cross section is then projected along the central axis to obtain a two-dimensional point cloud of the cross section.

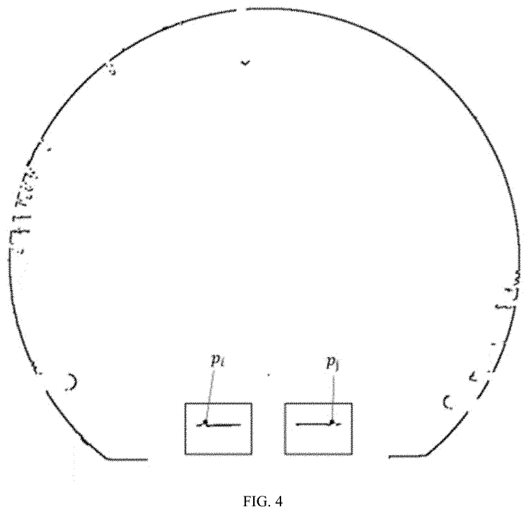

S3) Point clouds of two rails are extracted from the point cloud of the subway tunnel. Specifically, as shown in FIG. 4, a point pᵢ and a point pⱼ are respectively selected from the point clouds of the two rails, and then clustering is carried out using Euclidean distance such that the point clouds of the two rails is extracted. A distance threshold of the clustering is 0.02 m. The point cloud data circled in rectangular boxes in FIG. 4 is the point clouds of the two rails.

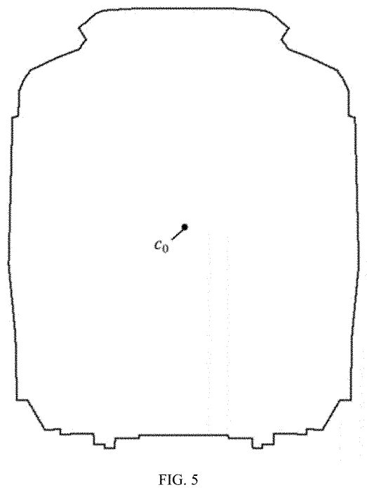

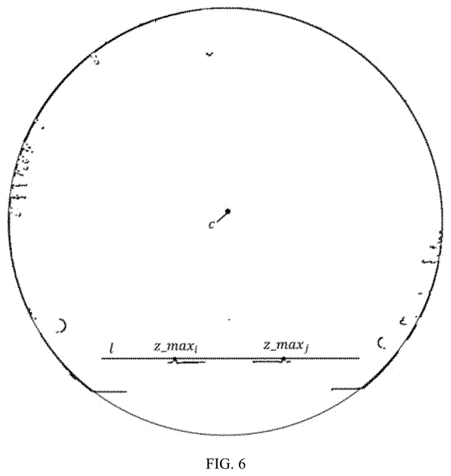

S4) As shown in FIGS. 5-6, a highest point z_maxᵢ and a highest z_maxⱼ of the point clouds of the two rails are selected to construct a base line l of a contour of tunnel clearance, and a slope k of the base line l is calculated; the two-dimensional point cloud of the cross section is subjected to circle fitting using random sample consensus (RANSAC) to obtain a center c of the cross section, and a bandwidth threshold of the circle fitting is 0.04 m; and a point cloud of the contour of the tunnel clearance is registered with the two-dimensional point cloud of the cross section according to the following two constraint conditions: 1) a bottom edge of the contour coincides with the base line l; and 2) an x-coordinate of a center co of the contour is equal to the x-coordinate of the center c of the cross section.

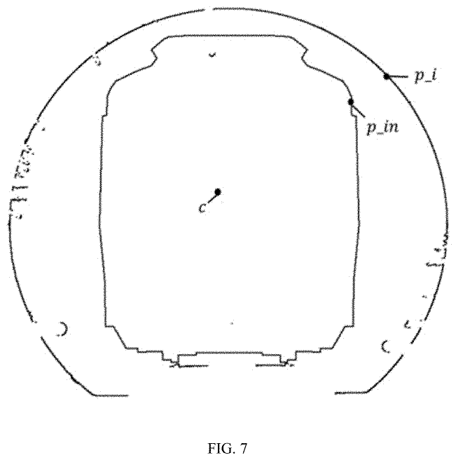

S5) Data analysis is carried out to determine the invasion. Specifically, as shown in FIG. 7, for any point p_i in the point cloud of the cross section of the tunnel, the closest point p_in in the point cloud of the contour of the tunnel clearance is searched through K-Nearest Neighbors (KNN), and then whether the clearance is intruded is judged by an intrusion function defined as follows:

S=∥p_i−c∥−∥p_in−c∥;

in which p_i is any point in the point cloud of the cross section of the tunnel; p_in is the closest point searched by KNN in the point cloud of the contour of the tunnel clearance; when S<0, the tunnel clearance is intruded; otherwise, the tunnel clearance is not intruded.

In this embodiment, an accurate calculation and analysis method is provided to determine whether the tunnel intrudes the clearance contour. Specifically, the point cloud of a subway tunnel is obtained. The point cloud of the subway tunnel is subjected to cylinder fitting. The central axis of the tunnel is extracted. The cross section of the subway tunnel is obtained. The point clouds of the two rails are extracted. The base line of a contour of tunnel clearance is constructed, and the center of the cross section is extracted. The point cloud of the cross section of the tunnel is registered with a point cloud of the contour based on constraint conditions. Data analysis is carried out to determine the intrusion. The method provided herein is simple and feasible for analyzing tunnel clearance, and can effectively reduce the difficulty in the clearance analysis of subway tunnel, avoid analysis errors caused by complex analysis and calculation, and improve the efficiency and accuracy of the clearance analysis.

### Embodiment 2

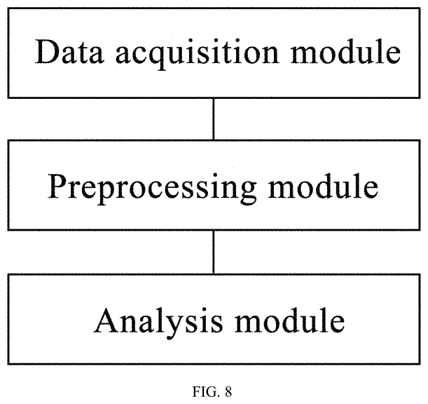

Based on the method for analyzing tunnel clearance based on the laser point cloud, this embodiment provides a device for analyzing tunnel clearance based on a laser point cloud. Specifically, FIG. 8 shows an optional structural diagram of the device, which includes a data acquisition module, a preprocessing module, and an analysis module.

The data acquisition module is configured to acquire 3D point cloud data of a subway tunnel. The subway tunnel is scanned through a tunnel detection vehicle based 3D laser scanner system, and 3D point cloud data of the subway tunnel is exported for subsequent preprocessing and analysis calculation.

The preprocessing module is connected to the data acquisition module, and is configured to pre-process the point cloud data of the subway tunnel, divide the point cloud data of the subway tunnel into sections of equal length, and extract the central axis of the subway tunnel and the point clouds of rails. The preprocessing module includes a dividing unit and an extraction unit. The dividing unit is configured to divide the point cloud of the subway tunnels into sections of equal length, such that the tunnel in each section contains 10 tunnel segments, which is convenient for subsequent batch processing. The extraction unit is configured to perform clustering using Euclidean distance, so as to extract the point clouds of the two rails.

The analysis module is connected to the preprocessing module, and is configured to construct a base line of a contour of the tunnel clearance, extract a center of the cross section of the tunnel and register the point cloud of the cross section of the tunnel and a point cloud of the contour according to a constraint condition.

In some embodiments, the analysis module includes a constraint calculation unit, a point cloud registration unit and an intrusion calculation unit. The constraint calculation unit is configured to construct the characteristic base line of the rail and fit a circle through RANSAC, and calculate the slope of the base line and the constraint conditions such as the center of the cross section. The point cloud registration unit, based on the above constraints, the clearance contour is registered with the point cloud of the cross section of the tunnel. The intrusion calculation unit is configured to determine whether the segments of the tunnel intrude the tunnel clearance using the defined intrusion function.

The above embodiments are illustrative of the present disclosure and not intended to limit the scope of the present disclosure. Various modifications and changes made by those of ordinary skill in the art without departing from the spirit and scope of the present disclosure shall fall within the scope of the application defined by the appended claims.

What is claimed is:

1. A method for analyzing tunnel clearance based on a laser point cloud, comprising:
1) obtaining a point cloud of a tunnel;
2) subjecting the point cloud of the tunnel to cylinder fitting; extracting a central axis of the tunnel; and extracting a point cloud of a cross section of the tunnel;
3) extracting point clouds of two rails from the point cloud of the tunnel;
4) constructing a base line of a contour of the tunnel clearance; extracting a center of the cross section of the tunnel; and registering the point cloud of the cross section of the tunnel and a point cloud of the contour of the tunnel clearance according to a constraint condition;
41) selecting a highest point in the point clouds of the two rails respectively to construct the base line; and calculating a slope of the base line;
42) subjecting the cross section of the tunnel to circle fitting using random sample consensus (RANSAC) to obtain the center of the cross section of the tunnel and an x-coordinate of the center; and
43) registering the point cloud of the cross section of the tunnel and the point cloud of the contour of the tunnel clearance according to the constraint condition: a) a bottom edge of the contour of the tunnel clearance coincides with the base line; and b) an x-coordinate of a center of the contour of the tunnel clearance is equal to the x-coordinate of the center of the cross section of the tunnel; and
5) analyzing the point cloud of the cross section of the tunnel and the point cloud of the contour of the tunnel clearance after being registered with each other to determine whether the tunnel clearance is intruded.

2. The method of claim 1, wherein the step (1) comprises:
scanning the tunnel using a three-dimensional laser scanner to obtain the point cloud of the tunnel; and
diving the point cloud of the tunnel into sections of equal length.

3. The method of claim 2, wherein the tunnel in each section contains 10 tunnel segments.

4. The method of claim 1, wherein the step (2) comprises:
21) subjecting the point cloud of the tunnel to the cylinder fitting through Gaussian mapping to extract the central axis of the tunnel;
22) extracting the point cloud of the cross section of the tunnel; wherein the point cloud of the cross section of the tunnel is defined as follows:
$${P}_{C} = \{ {t}_{i} ∈ {P}_{T} ‖ \frac{( {t}_{i} - {a}_{i} ) \cdot T}{‖ {t}_{i} - {a}_{i} ‖} \vert < ɛ \} ;$$
where P_{C} is the point cloud of the cross section of the tunnel; tᵢ is a point in the point cloud of the tunnel; P_{T} is the point cloud of the tunnel; aᵢ is a point on the central axis of the tunnel; T is a unit tangent vector of the central axis at the point aᵢ; and ε is a threshold; and
23) projecting the point cloud of the cross section of the tunnel along the central axis of the tunnel to obtain a two-dimensional point cloud of the cross section of the tunnel.

5. The method of claim 1, wherein the step (3) comprises:
extracting point clouds of the two rails from the point cloud of the tunnel;
selecting points pᵢ and pⱼ from the point clouds of the two rails; and
clustering the point clouds of the two rails using Euclidean distance.

6. The method of claim 1, wherein the step (5) comprises:
for a point p_i in the point cloud of the cross section of the tunnel, searching the closest point p_in in the point cloud of the contour of the tunnel clearance through K-Nearest Neighbors (KNN); and
determining whether the tunnel clearance is intruded through an intrusion function:
S=∥p_i−c∥−∥p_in−c∥;
wherein p_i is any point in the point cloud of the cross section of the tunnel; p_in is the closest point searched by KNN in the point cloud of the contour of the tunnel clearance; c is the center of the cross section of the tunnel; and when S<0, the tunnel clearance is intruded; otherwise, the tunnel clearance is not intruded.

7. A device for analyzing tunnel clearance based on a laser point cloud, comprising:
a data acquisition module, configured to acquire a point cloud of a tunnel;
a preprocessing module, configured to subject the point cloud of the tunnel to cylinder fitting, extract a central axis of the tunnel, extract a point cloud of a cross section of the tunnel and extracting point clouds of two rails from the point cloud of the tunnel; and
an analysis module, configured to construct a base line of a contour of the tunnel clearance, extract a center of the cross section of the tunnel and register the point cloud of the cross section of the tunnel and a point cloud of the contour of the tunnel clearance according to a constraint condition.

8. A system for analyzing tunnel clearance based on a laser point cloud, comprising:
a three-dimensional scanner;
a processor;
a storage; and
a program, stored on the storage, for executing the method of claim 1;
wherein the system is mounted on a tunnel inspection vehicle; and
the three-dimensional scanner is connected to the processor, and is configured to scan the tunnel to obtain point cloud of the tunnel and send the obtained point cloud of the tunnel to the processor.
